(19) United States
(12) Patent Application Publication
(10) Pub. No.: US 2005/0175292 A1
(43) Pub. Date: Aug. 11, 2005

(54) Method for coupling a surface-oriented optoelectronic component to an optical fiber

(76) Inventor: Dipl.-Ing. Daniel Supper, Hohenbrunn (DE)

Correspondence Address: ESCHWEILER & ASSOCIATES, LLC;NATIONAL CITY BANK BUILDING, 629 EUCLID AVE., SUITE 1210, CLEVELAND, OH, 44114, US

(21) Appl. No.: 10/772,632

(22) Filed: Feb. 5, 2004

(51) Int. Cl. G02B 6/36

(52) U.S. Cl. 385/88; 385/90

(57) ABSTRACT

The invention provides a method in which a fiber is held at a holding point arranged at a predetermined distance from the end face in such a way that the end face can perform a pivoting movement about the holding point. The end face of the fiber and the component are brought close to one another in the context of a coarse adjustment in such a way that a fine adjustment is subsequently effected between the component and the fiber in the context of an automatic self-centering by pivoting the fiber about the holding point.

The invention relates to a method for coupling a surface-oriented optoelectronic component to an optical fiber, to an arrangement for carrying out this method, and also to optoelectronic modules having a surface-oriented optoelectronic component and an optical fiber.

### PRIOR ART

The published German patent application DE 101 43 781 A1 and its parallel U.S. patent application 2003/0053764 A1 disclose a method for coupling a surface-oriented optoelectronic component to an optical fiber. In this method, firstly a projecting structure is formed on the optoelectronic component, said structure being arranged rotationally symmetrically with respect to the optically active zone of the optoelectronic component. The end face of the fiber and/or the projecting structure of the component are subsequently wetted with a transparent adhesive. Afterward, the optoelectronic component is placed onto the end face of the fiber, aligned perpendicularly with respect to the component, and then “set free”, so that it is separated from any external holding components or holding forces. The component is thus arranged in floating fashion on the end face of the fiber by means of the transparent adhesive and is carried by the adhesive, as a result of which the component can be displaced perpendicular to the axis of rotation of the optical fiber. The generally relatively light component then moves under the action of the surface tension of the adhesive relative to the end face of the fiber and positions itself centrally with respect to the axis of the fiber. Under the influence of the surface tension, the surfaces of the adhesive form minimum areas, the component and its projecting structure which is formed in rotationally symmetrical fashion being automatically centered with respect to the fiber center. Since the component has to be able to move freely in the case of the previously known method, it is not possible to fix and contact-connect the component in a housing before the adjustment with respect to the fiber.

### OBJECT OF THE INVENTION

The invention is based on the object of specifying a method for coupling a surface-oriented optoelectronic component to an optical fiber. The method is intended to achieve an optimum adjustment between the fiber and the component in a particularly simple manner. The method is intended to make it possible, particularly, firstly to fix, and if appropriate to contact-connect, the component in a housing and only afterward to carry out the adjustment of the fiber.

An automatic adjustment between fiber and component is referred to below for short as “self-centering”. SUMMARY OF THE INVENTION

In order to achieve the abovementioned object, the invention provides a method having the features in accordance with patent claim 1. Advantageous refinements of the method according to the invention are specified in the subclaims.

Accordingly, the invention provides for the fiber to be held at a holding point arranged a predetermined distance from the end face in such a way that the end face of the fiber can perform a pivoting movement about the holding point. Afterward, the end face of the fiber and the component are brought close to one another in the context of a coarse adjustment in such a way that a fine adjustment is subsequently effected between the optically active zone of the component and the end face of the fiber in the context of an automatic “self-centering” by pivoting the fiber about the holding point.

One essential advantage of the method according to the invention is that the optoelectronic component may already be fixed in a housing before the coarse and fine adjustment, since the fine adjustment between the fiber and the component may be effected solely by pivoting the fiber about the holding point. Although it is possible for the optoelectronic component to be moved for the purpose of adjustment, this is not absolutely necessary.

An automatic self-centering can be carried out particularly simply and thus advantageously if the component has a projecting structure arranged rotationally symmetrically with respect to the optically active zone of the optoelectronic component. In such a case, the end face of the fiber and/or the projecting structure of the component are/is wetted with a transparent adhesive, and the component and the fiber are subsequently brought close to one another. In this case, the adhesive propagates between the end face of the fiber and the projecting structure, thereby bringing about the self-centering of the fiber by pivoting about the holding point. With regard to the “self-centering” operation, reference shall be made by way of example to the published German patent application DE 101 43 781 A1 and also to its parallel U.S. patent application 2003/0053764 A1.

In order to avoid the situation in which, after the fiber has been self-centered relative to the component, the fiber can slip or be shifted off-center, in accordance with an advantageous refinement of the method, after the self-centering, a curing of the adhesive is brought about, thereby achieving a fixing of the centered arrangement of the fiber. The adhesive may be cured for example by irradiating the adhesive with UV beams, if a UV-curable adhesive is involved.

The optoelectronic component can be mounted in a housing particularly simply and thus advantageously if the component is mounted before the optical fiber is fitted. Therefore, it is regarded as advantageous if the component is fixed in a housing and only afterward is the fiber subjected to coarse adjustment relative to the component fixed in the housing.

Preferably, the component is contact-connected after being fixed in the housing; the coarse adjustment of the end face of the fiber is then carried out relative to the component which has been fixed and already contact-connected in the housing.

In order to avoid the situation in which the fiber fixed to the optoelectronic component can tear off, a strain relief device is preferably fitted to the housing and to the fiber. The strain relief device is formed for example by a ferrule which is fixed, for example by adhesive bonding, to the housing and to the fiber.

The ferrule may already be pushed onto the fiber before the coarse adjustment. In such a case, the ferrule is preferably pushed into such a region of the fiber which lies outside the pivoting range of the fiber delimited by the end face of the fiber and the holding point; what is thereby achieved is that the fiber can pivot about the holding point in an undisturbed manner in the context of the fine adjustment. As an alternative, the ferrule may also form the holding point about which the fiber pivots.

As an alternative, the ferrule may be pushed onto the fiber at that end thereof which is remote from the self-adjusting end side of the fiber; this is then preferably done after the fiber has been self-centered relative to the component and the fiber has been fixed to the component.

Preferably, after the fiber has been fixed to the component, a coupling device is fitted to or formed at that end of the fiber which is remote from the end face, by means of which coupling device the fiber can be connected to further optical components. The coupling device may be formed for example by a receptacle—or a plug or a socket—or a fiber pigtail.

In order to fix the optoelectronic component in the housing, the latter preferably has a carrier in which a passage hole is formed. The component is fixed on a side of said carrier in such a way that the optically active zone of the component faces the passage hole. The fiber is led through the passage hole, and the coarse adjustment of the fiber relative to the component is subsequently effected.

The term “active zone” of the component is understood hereinafter to mean the coupling-in and/or -out window or the coupling-in and/or -out area for coupling the light in and/or out. If the component is a receiving element (e.g. photodiode), then the active zone thus denotes the coupling-in window or the coupling-in area (coupling-in outer side) of the component for coupling in light; if the component is a transmitting element (e.g. laser, light-emitting diode), then the “active zone” denotes the coupling-out window or the coupling-out area (coupling-out outer side) of the component for coupling out light.

The electrical connections of the component are preferably electrically connected to conductor tracks present on the carrier. In this case, the electrical connections of the component preferably lie in the region of the passage hole of the carrier, the conductor tracks projecting into the region of the passage hole. The conductor tracks form a type of mechanical suspension at which the component is held in the region of the passage hole. The mechanical suspension results in a degree of mechanical flexibility of the optoelectronic component relative to the carrier, so that the component is mounted such that it is flexible or can be moved slightly perpendicularly to the carrier. Consequently, it is possible, by way of example, to effect a degree of compensation of mechanical stresses on account of thermal effects or thermal material expansions.

Moreover, the diameter of the rotationally symmetrical projecting structure is preferably chosen to have exactly the same magnitude as the diameter of the fiber, in order to achieve an optimum fine adjustment between the end face of the fiber and the optically active zone of the component.

In order to ensure that the position of the projecting structure relative to the position of the optically active zone is optimal and does not have an undesirable offset, the position of the projecting structure and the position of the optically active zone of the component are defined in the context of one and the same lithography step.

The surface-oriented optoelectronic component may be, by way of example, a VCSEL laser diode, an LED or a photodiode.

Furthermore, it is regarded as advantageous if the optical fiber is connected by both ends to optoelectronic components in the manner described above. This means that a further component is connected to the other end of the fiber. In this way, it is possible to achieve a “plug-free” connection between two optoelectronic components. By way of example, it is possible—in particular for short optical links—to form a transmitter and receiver unit which manages without two cost-intensive optical plug connections, since the fiber is linked to the two components in the context of a self-centering of the fiber with subsequent fixing.

The invention further relates to an apparatus for coupling a surface-oriented optoelectronic component to an optical fiber. The apparatus according to the invention has a baseplate for holding the component, and has a holding element arranged at a predetermined distance from the baseplate. The holding element serves to hold the fiber and enables a pivotable movement of the fiber in a pivoting range of the fiber delimited by the end face of the fiber and the holding point above the baseplate.

The method according to the invention described in the introduction can be carried out by means of the apparatus described. With regard to the advantages of the apparatus according to the invention, reference is therefore made to the above explanations in connection with the method according to the invention.

Furthermore, an optoelectronic module having a surface-oriented optoelectronic component, having an optical fiber and having a housing is regarded as an invention. The housing has a carrier with a passage hole. The component is fixed on a side of the carrier in such a way that the active zone of the component faces the passage hole. The fiber is led through the passage hole and the component and the fiber are coupled. The electrical connections of the component are electrically connected to conductor tracks present on the carrier of the housing. The electrical connections of the component lie in the region of the passage hole, and the conductor tracks project into the region of the passage hole. The conductor tracks thus project beyond the edge of the passage hole for the purpose of contact-connection and form a “freely floating” suspension for the component.

With regard to the advantages of the optoelectronic module described, reference is made to the above explanations in connection with the method according to the invention.

### EXEMPLARY EMBODIMENTS

In order to elucidate the invention:

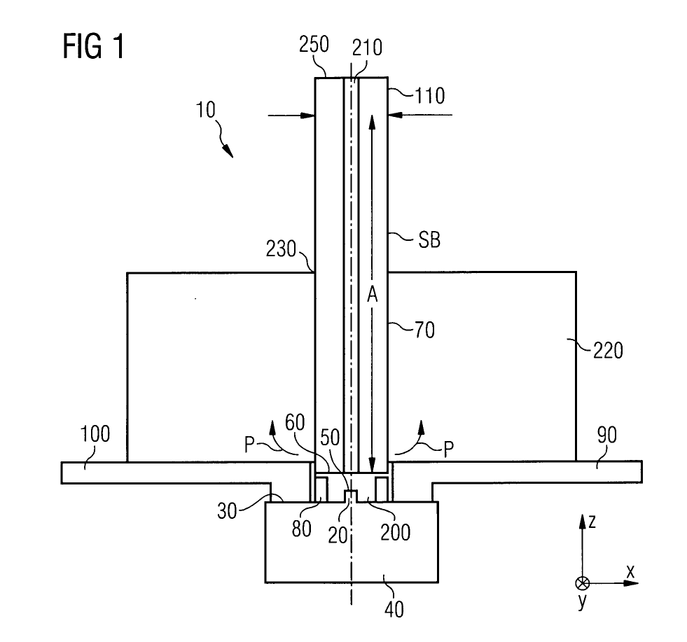

FIG. 1 shows a first exemplary embodiment of an optoelectronic module according to the invention, which has been produced by the method according to the invention,

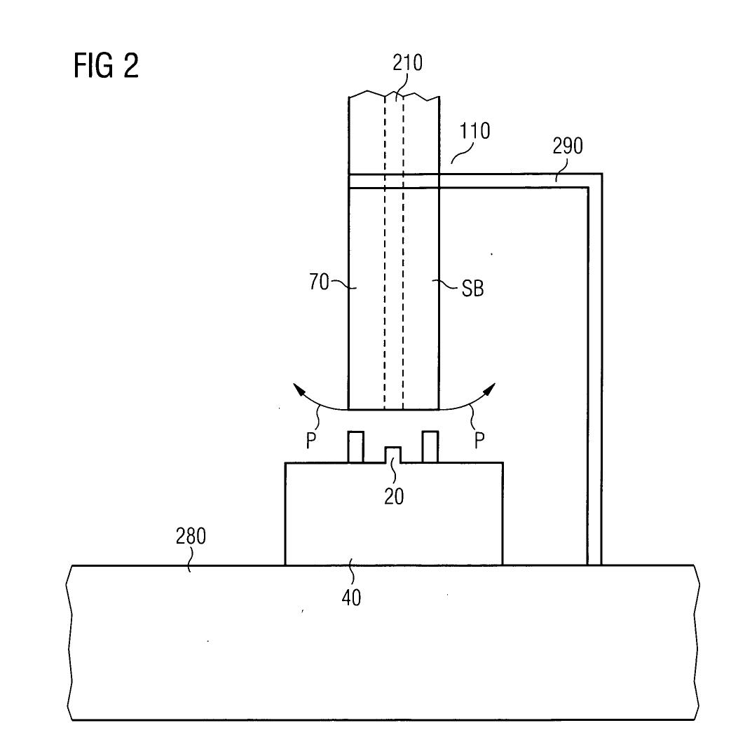

FIG. 2 shows an exemplary embodiment of an arrangement for carrying out the method according to the invention and for producing the module in accordance with FIG. 1,

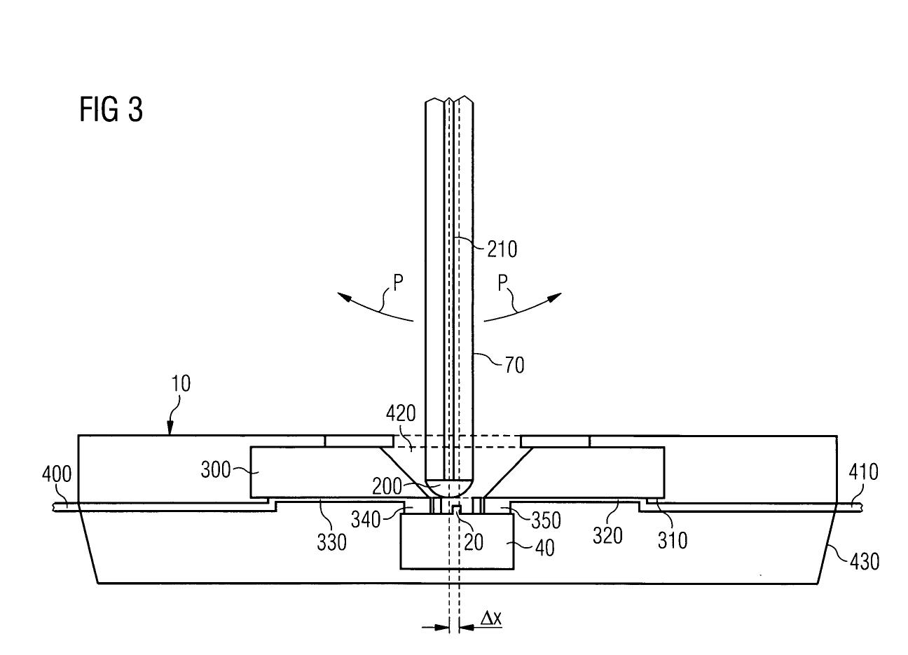

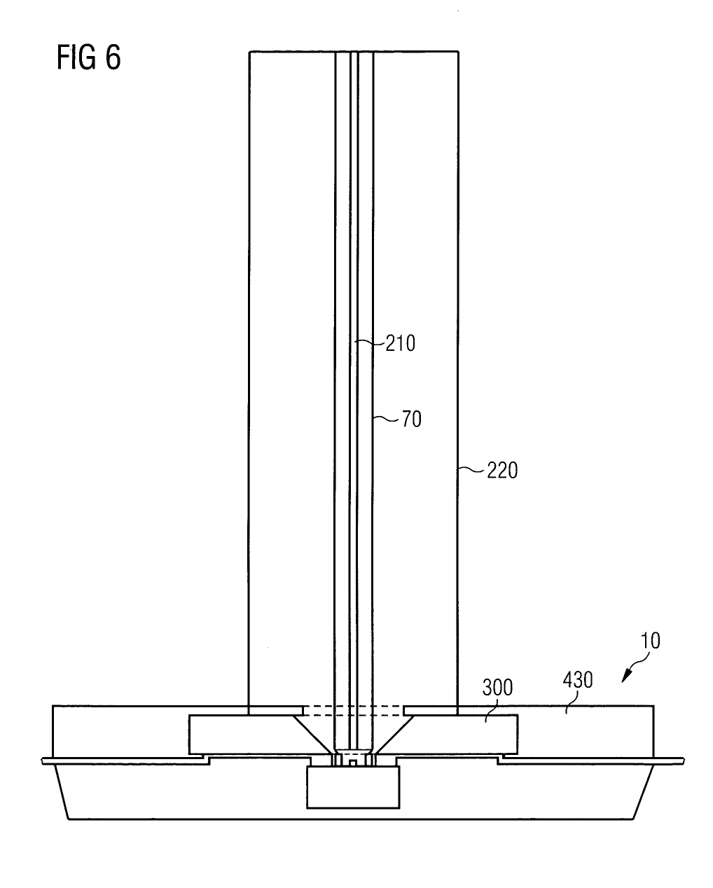

FIGS. 3 to 6 diagrammatically show by way of example a method for producing a second exemplary embodiment for an optoelectronic module according to the invention,

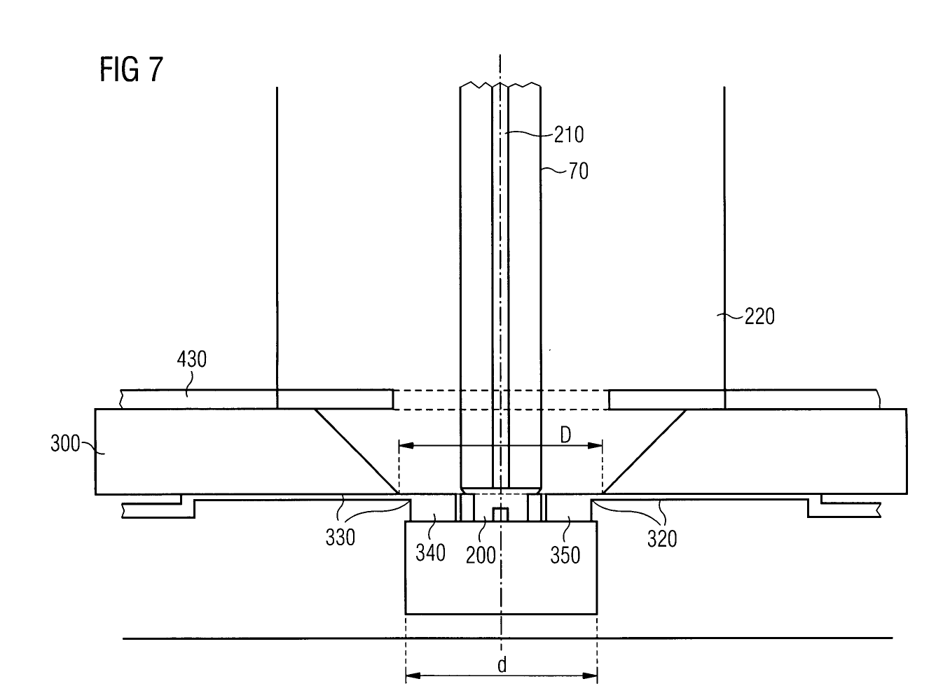

FIG. 7 shows a third exemplary embodiment of an optoelectronic module according to the invention, and

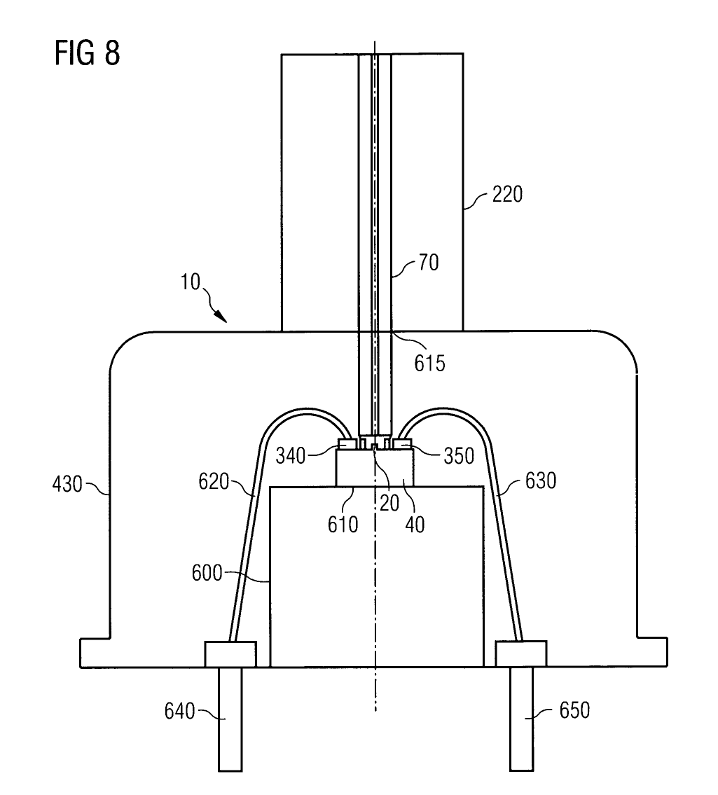

FIG. 8 shows a fourth exemplary embodiment of an optoelectronic module according to the invention.

The same reference symbols are used for identical or comparable components in FIGS. 1 to 8 in order to afford a better understanding.

FIG. 1 reveals an optoelectronic module 10. The module 10 has a surface-oriented optoelectronic component 20 arranged on a top side 30 of a substrate 40. An active zone 50 of the optoelectronic component 20 faces an end side 60 of an optical fiber 70 (e.g. glass fiber or polymer fiber).

The optoelectronic component 20 is surrounded by a rotationally symmetrical projecting structure 80. The rotationally symmetrical structure 80 projects with respect to the top side 30 of the substrate 40 and may project above the component 20, for example. As an alternative, the rotationally symmetrical structure 80 may have for instance the same height as the component 20.

FIG. 1 furthermore reveals that the component 20 is connected to contacts 90 and 100 of a housing of the module 10, said housing not being illustrated any further in FIG. 1. The two contacts 90 and 100 serve for the electrical contact-connection or for the electrical connection of the component 20.

The optical fiber 70 is held pivotably at a holding point 110 above the component 20. The holding point 110 is at a predetermined distance A from the end side 60 of the fiber 70, so that the end side 60 of the fiber 70 can carry out a pivoting movement along the arrow direction P. By means of a pivoting along the pivoting direction P, the end side 60 of the fiber 70 can thus be aligned relative to the active zone 50 of the optoelectronic component 20. The pivoting range of the fiber 70 delimited by the holding point 110 and the end side 60 bears the reference symbol SB in FIG. 1.

The adjustment of the end side 60 of the fiber 70 will now be explained in detail: firstly, an adhesive 200 is introduced into the rotationally symmetrical projecting structure 80, so that the active zone 50 of the component 20 is wetted. As an alternative or in addition, the end side 60 of the fiber 70 may also be wetted with the adhesive 200.

Afterward, the end side 60 of the fiber 70 is coarsely preadjusted relative to the component 20. This coarse adjustment is effected in such a way that the holding point 110 and thus the fiber 70 are brought close to the component 20.

As soon as the end side 60 of the fiber 70 and the active zone 50 of the component 20 come into contact with the adhesive 200, the end face 60 is automatically centered relative to the component 20 on account of the surface tension of the adhesive 200. Consequently, in contrast to the coarse adjustment, the fine adjustment takes place entirely by itself, without the need for external targeted influencing. This effect of “self-centering” is described in the published German patent application DE 101 43 781 A1 and in its parallel U.S. patent application 2003/0053764 A1.

The adjustment accuracy with which the end side of the fiber 60 is aligned relative to the component 20 depends substantially on the arrangement of the rotationally symmetrical projecting structure 80. In order to ensure that the end side 60 of the fiber 70 is aligned centrically, that is to say with the fiber core 210 of the fiber 70 exactly above the active zone 50 of the component 20, the projecting structure 80 has to be centered relative to the component 20. In order to avoid the situation in which there may be an undesirable positional deviation between the projecting structure 80 and the component 20, the component 20 and the rotationally symmetrical projecting structure 80 are produced in one and the same lithography step on the substrate 40.

FIG. 1 additionally reveals a ferrule 220, which is plugged onto the optical fiber 70. The ferrule 220 is adhesively bonded both to the fiber 70 and to the two contacts 90 and 100 of the module 10, so that the ferrule forms a strain relief device.

In order to avoid thermal problems, in particular mechanical strains on account of changes in temperature, as little adhesive as possible should be used for adhesively bonding the ferrule 220 to the fiber 70 and to the two contacts 90 and 100. In order to make this possible, the ferrule 220 has a fitting hole 230 (or fit), the internal diameter of which corresponds as well as possible to the external diameter of the fiber 70, so that as little space as possible remains for adhesive between the fiber 70 and the ferrule 220. The adhesive bonding areas between the ferrule 220 and the two contacts 90 and 100 should also be made as small and thin as possible for thermal reasons.

The ferrule 220 may be pushed onto the fiber 70 after the adjustment thereof. If the ferrule 220 is pushed onto the fiber 70 before the adjustment and fixing of the fiber 70 to the component 20, the ferrule 220 should be positioned in such a way that it is situated outside the pivoting range SB of the fiber 70 delimited by the end face 60 and the holding point 110.

As an alternative, the ferrule 220 may also be pushed onto the fiber 70 after the latter has been fixed to the component 20. In such a case the ferrule 220 is plugged on at that end of the fiber 70 which is opposite to the end side 60.

In the context of the preadjustment or coarse adjustment, the fiber 70 is preadjusted only very coarsely with an accuracy of only approximately ±10 μm. In this case, the end side 60 of the fiber 70 is at a distance of approximately 2 to 20 mm from the component 20. Since the fiber is held pivotably in the holding point 110, the end side 60 can pivot freely, that is to say “reciprocate”.

Afterward, the fiber 70 is brought into contact with the adhesive 200 and the component 20 by the fiber 70 being moved or brought downward, and thus in the direction of the component 20, counter to the z direction depicted in FIG. 1; this results in an automatic self-centering of the fiber 70 within a few milliseconds. The self-centering speed depends on the viscosity of the adhesive 200. The self-centering is effected by the surface tension of the adhesive 200 and/or by the capillary action of the adhesive 200, because the adhesive 200 and also the end side 60 of the fiber 70 can be moved in the x and y direction relative to the top side 30 of the substrate 40. The adjustment accuracy between the fiber core 210 of the fiber 70 and the active zone 50 of the component 50 is approximately ±0.5 μm to ±1.0 μm and thus also suffices for adjustment of single-mode fibers. The fiber 70 may thus be a multimode fiber or a single-mode fiber; the method described is suitable for both types of fiber.

The diameter of the projecting structure 80 is preferably identical to the external diameter of the optical fiber 70 in order to enable an optimum self-adjustment.

In order to prevent the fiber from slipping after the self-adjustment of the fiber 70 relative to the component 20, the adhesive 200 is cured after fine adjustment has been effected. The adhesive 200 is preferably a UV-curable or thermally curable adhesive. Afterward, the ferrule 220 is fitted to the housing and to the fiber in the manner described, thereby forming a strain relief for the fiber 70.

The end 250 of the fiber 70 that is remote from the end side 60 may be connected to a further component (not illustrated in FIG. 1) in a corresponding manner. A plug- and socket-free connection between the two components is achieved in such a case. Such an optical connection is advantageous particularly in the case of short transmitter and receiver units, for example within computer systems.

As an alternative, a plug, a socket or a receptacle may also be arranged at the end 250 of the fiber 70 in order to enable a connection to other optical waveguides or to other optical components. As an alternative, a fiber pigtail may also be provided.

FIG. 2 shows an exemplary embodiment of an arrangement which can be used to produce the optoelectronic module 10 in accordance with FIG. 1. A baseplate 280 can be seen, on which the substrate 40 with the component 20 is arranged. The fiber 70 is suspended above the substrate 20 at the holding point 110, which is effected by a holding element 290. The holding element 290 is configured in such a way that it enables a coarse adjustment of the fiber 70 relative to the component 20. It is possible to achieve adjustment accuracy of about ±10 μm in the x-y direction and a few millimeters in the z direction.

After coarse adjustment has been effected, the end side 60 of the fiber 70 is automatically aligned relative to the component 20—as described above. The angular error, which possibly arises on account of the pivoting movement along the pivoting direction P, between the longitudinal axis of the fiber core 210 and the normal to the surface of the active zone 50 of the component 20 is less than approximately 1 degree, so that this angular error is not problematic.

A second exemplary embodiment of an optoelectronic module will now be explained with reference to FIGS. 3 to 6. In this connection, by way of example, the method for coupling an optoelectronic component to an optical fiber is also shown in detail again. In this case, for components which have already been explained in connection with FIGS. 1 and 2, the reference symbols already introduced in connection with these figures will continue to be used.

FIG. 3 reveals an optoelectronic module 10 with a carrier 300, on the front side 310 of which conductor tracks 320 and 330 are arranged. The conductor tracks 320 and 330 are connected to connections 340 and 350 of a component 20 arranged on a top side 30 of a substrate 40. The connections 340 and 350 and also the conductor tracks 320 and 330 enable the component 20 to be electrically connected to the external connection pins 400 and 410 of the module 10.

As can be seen in FIG. 3, an offset Δx is present between the center of a fiber core 210 of a fiber 70 and the active zone 50 of the component 20.

This offset Δx arises in the context of the coarse adjustment of the fiber 70 above the optically active zone 50 of the component 20. In order to enable the adjustment of the fiber 70, the carrier 300 has a passage hole 420, through which the fiber 70 is led. The optically active zone 50 of the component 20 faces the passage hole 420 in order to enable an adjustment of the end side 60 of the fiber 70 above the active zone 50.

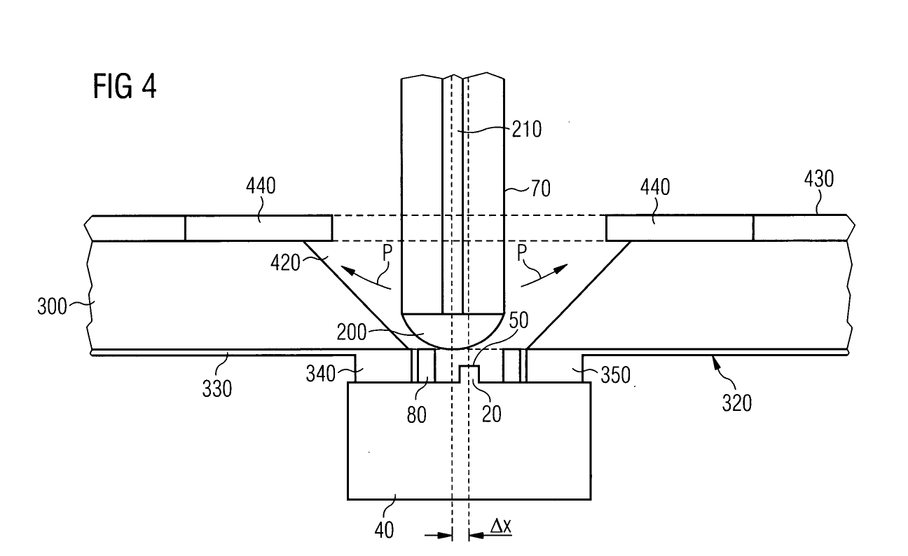

FIG. 4 shows the arrangement of the fiber 70 and of the component 20 in detail again after coarse adjustment has been effected. In particular, it can readily be discerned in FIG. 4 that the carrier 300 is adhesively bonded to a housing 430 of the module 10 by means of two adhesive bonding locations 440.

The housing 430 may be a TSSOP package, by way of example.

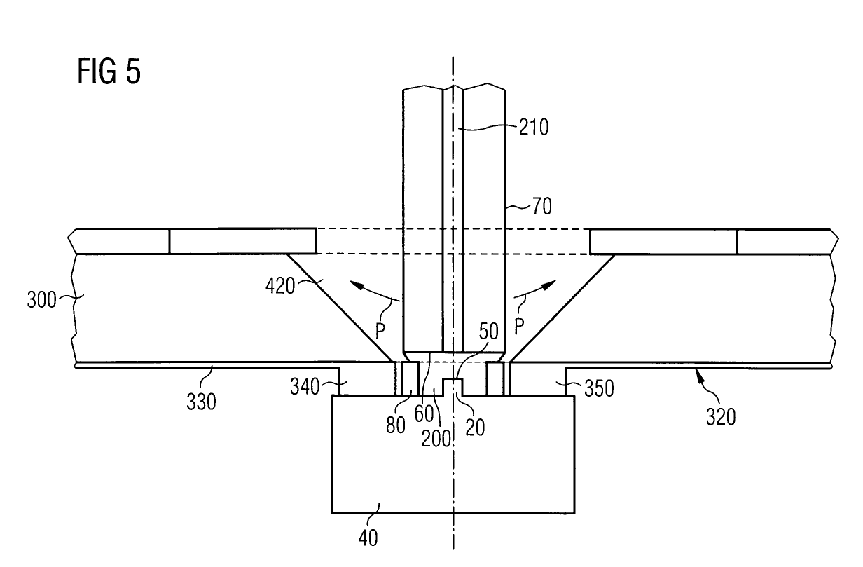

FIG. 5 shows the arrangement of the fiber 70 relative to the component 20 after self-centering of the end side 60 of the fiber 70. It can be seen that the fiber core 210 is arranged centrally above the active zone 50 of the component 20. The offset Δx is smaller than ±1.5 μm.

It can furthermore be seen that the size of the passage hole 420 is chosen to be precisely large enough that the fiber 70 can be pushed through and adjusted. The connections 340 and 350 of the component 20 are arranged in such a way that they are connected to the conductor tracks 320 and 330 in the region of the carrier 300: this means that the conductor tracks 320 and 330 rest fixedly in the contact region with the connections 340 and 350 on the carrier 300.

It can be seen in connection with FIGS. 3 to 6 that the component 20 is firstly fixed and electrically contact-connected on the carrier 300 and thus in the housing 430 before the fiber 70 is adjusted relative to the component 20 which has been fixed and contact-connected. The end side 60 of the fiber 70 is thus adjusted relative to the component 20 which has already been mounted and contact-connected. This makes it possible, for example, directly after the fiber 70 has been self-centered, to activate the component 20 and to check the quality or the adjustment accuracy of the fiber.

After the fine adjustment of the fiber 70 relative to the component 20, the adhesive 200 present between the end side 60 and the component 20 is cured, for example by irradiation with UV light or by heating. Afterward, a strain relief device in the form of a ferrule is adhesively bonded both to the fiber 70 and to the housing 430. In this case, as little adhesive as possible is used in order to avoid mechanical strains in the case of changes in temperature.

FIG. 7 shows a third exemplary embodiment of an optoelectronic module. In the case of this optoelectronic module, the size (diameter D) of the passage hole 420 is chosen to be large enough that the connections 340 and 350 of the component 20 lie in the inner region of the passage hole 420. The distance d of the connections of the component 20 is thus smaller than the diameter D. In the exemplary case in accordance with FIG. 7, even the size of the substrate 40 is smaller than the diameter D of the passage hole 420.

In order nevertheless to enable an electrical connection between the connections 340 and 350 of the component 20 and the conductor tracks 320 and 330, the conductor tracks 320 and 330 project into the region of the passage hole 420, that is to say without bearing directly on the carrier 300. The conductor tracks 320 and 330 are thus fixed on the carrier 300 only outside the passage hole 420, and they project beyond the carrier 300 in the interior of the passage hole 420.

Preferably, firstly the conductor tracks 320 and 330 are applied on the carrier 300; afterward, the component 20 is contact-connected to the conductor tracks 320 and 330. Only then is the passage hole 420 etched, by way of example. This ensures that the conductor tracks 320 and 330 cannot break off during contact-connection to the component 20, since, at the time of contact-connection, they bear completely on the carrier 300, which is still “free of passage holes”.

The fixing of the component 20 and thus of the substrate 40 to the carrier 300 is thus effected exclusively by the conductor tracks 320 and 330, so that the connection between the component 20 and the carrier 300 is only indirect. This indirect connection between the carrier 300 and the component 20 enables a degree of mobility of the component 20 in the z direction relative to the carrier 300 and thus relative to the fiber 70. This degree of flexibility on account of the “suspension” of the component on the conductor tracks 320 and 330 has the effect that it is possible to compensate for thermal stresses that possibly occur between the fiber 70 and the component 20.

In contrast to the “rigid” fixing of the component 20 on the carrier 300 in accordance with FIGS. 3 to 6, the exemplary embodiment in accordance with FIG. 7 thus confirms a “flexible” fixing of the component 20 on the carrier 300 by “suspension” from conductor tracks.

FIG. 8 shows a fourth exemplary embodiment of an optoelectronic module 10. The module 10 has a housing 430 in the form of a TO package. A carrier 600 is provided in the housing 430, on which carrier a substrate 40 is arranged by its rear side 610. The front side 30 of the substrate 40 and thus the component 20 face a fiber 70. The fiber 70 is led through a housing opening 615 of the housing 430. The fiber 70 is assigned a strain relief device in the form of a ferrule 220, which is adhesively bonded both to the housing 430 and to the fiber 70.

Moreover, FIG. 8 reveals bonding wires 620 and 630, by means of which the connections 340 and 350 of the component 20 are contact-connected. The bonding wires 620 and 630 are connected to external connection pins 640 and 650 of the module 10.

List of reference symbols

| | |
|---|---|
| 10 | Optoelectronic module |
| 20 | Optoelectronic component |
| 30 | Top side of a substrate |
| 40 | Substrate of the |
| | component |
| 50 | Active zone of the |
| | component |
| 60 | End side of a fiber |
| 70 | Optical fiber |
| 80 | Rotationally symmetrical |
| | projecting structure |
| 90, 100 | Contacts of a housing |
| 110 | Holding point |
| 200 | Adhesive |
| 210 | Fiber core |
| 220 | Ferrule |
| 230 | Fitting hole |
| 250 | Remote end of the fiber |
| 280 | Baseplate |
| 290 | Holding element |
| 300 | Carrier |
| 310 | Front side of the |
| | carrier |
| 320, 330 | Conductor tracks |
| 340, 350 | Contacts |
| 400, 410 | External connection pins |
| 420 | Passage hole |
| 430 | Housing |
| 440 | Adhesive bonding |
| | locations |
| 600 | Carrier |
| 610 | Rear side of the |
| | substrate |
| 615 | Housing opening |
| 620, 630 | Bonding wires |
| 640, 650 | External connection pins |
| S | Pivoting direction |
| SB | Pivoting range of the |
| | fiber |

1. A method for coupling a surface-oriented optoelectronic component to an end face of an optical fiber, comprising:
arranging the fiber at a holding point a predetermined distance from the end face in such a way that the end face can perform a pivoting movement about the holding point; and
bringing the end face of the fiber and the component close to one another in the context of a coarse adjustment in such a way that a fine adjustment is subsequently effected between the component and the fiber in the context of an automatic self-centering by pivoting the fiber about the holding point.

2. The method as claimed in claim 1, further comprising:
providing a projecting structure arranged rotationally symmetrically with respect to an optically active zone of the component;
wetting the end face of the fiber the projecting structure of the component with a transparent adhesive; and
bringing close together the component and the fiber in such a way that the adhesive propagates between the end face of the fiber and the projecting structure, thereby bringing about a self-centering of the fiber relative to the component.

3. The method as claimed in claim 2, further comprising, after the self-centering, curing of the adhesive for the purpose of fixing the centered arrangement between the fiber and the projecting section.

4. The method as claimed in claim 1, further comprising fixing the component in a housing prior to subjecting the end face of the fiber to coarse adjustment relative to the component fixed in the housing.

5. The method as claimed in claim 4, wherein the component is contact-connected after being fixed in the housing and the coarse adjustment of the end face of the fiber is effected relative to the component which has been fixed in the housing and contact-connected.

6. The method as claimed in claim 1, further comprising fitting a strain relief device to a housing that receives the the fiber to couple to the component.

7. The method as claimed in claim 6, wherein the strain relief device comprises a ferrule fixed to the housing and to the fiber.

8. The method as claimed in claim 7, further comprising pushing the ferrule onto the fiber before the coarse adjustment.

9. The method as claimed in claim 8, wherein the ferrule is pushed into a region of the ferrule which lies outside a pivoting range of the fiber delimited by the end face of the fiber and the holding point.

10. The method as claimed in claim 7, wherein the ferrule is pushed onto the fiber at an end of the fiber which is remote from the end face after the fiber has been self-centered relative to the component and the fiber has been fixed to the component.

11. The method as claimed in claim 7, wherein the ferrule is adhesively bonded both to the fiber and to the housing.

12. The method as claimed in claim 1, wherein, after the fiber has been fixed to the component, fitting a coupling device to or forming the coupling device at that end of the fiber which is remote from the end face.

13. The method as claimed in claim 12, wherein the coupling device by comprises a receptacle or a fiber pigtail.

14. The method as claimed in claim 4, further comprising:
forming a passage hole in a carrier of the housing;
fixing the component on a side of the carrier in such a way that the optically active zone of the component faces the passage hole; and
directing the fiber through the passage hole for the coarse adjustment thereof.

15. The method as claimed in claim 14, further comprising:
electrically connecting electrical connections of the component to conductor tracks present on the carrier, wherein
the electrical connections reside in a region associated with the passage hole and the conductor tracks projecting into the region of the passage hole.

16. The method as claimed in claim 2, wherein the diameter of the projecting structure is chosen to have exactly the same magnitude as the diameter of the fiber.

17. The method as claimed in claim 2, wherein a position of the projecting structure and a position of the optically active zone of the component are defined in the context of one and the same lithography step.

18. The method as claimed in claim 1, wherein the surface-oriented optoelectronic component comprises a VCSEL laser diode, an LED or a photodiode, and is coupled to the fiber.

19. The method as claimed in claim 1, wherein, in the manner described, one component is connected to one end of the fiber and a further component is connected to the other end of the fiber.

20. An apparatus for coupling a surface-oriented optoelectronic component to an optical fiber, comprising:
a baseplate for holding the component; and
a holding element configured to hold the component at a predetermined distance from the baseplate,
the holding element serving to hold the fiber and enabling a pivotable movement of the fiber in a pivoting range of the fiber delimited by the end face of the fiber and the holding point above the baseplate.

21. An optoelectronic module having a surface-oriented optoelectronic component, having an optical fiber and having a housing, wherein
the housing comprises a carrier with a passage hole,
the component being fixed on a side of the carrier in such a way that an active zone of the component faces the passage hole, and wherein
the fiber extends through the passage hole and couples to the component, and wherein
electrical connections associated with the component are electrically connected to conductor tracks present on the carrier, and wherein
the electrical connections of the component reside in the region of the passage hole and the conductor tracks project into the region of the passage hole to form a suspension for the component.
